(19) United States
(12) Patent Application Publication
(10) Pub. No.: US 2015/0134409 A1
(43) Pub. Date: May 14, 2015

(54) ACCURATE MECHANISM FOR ESTIMATING A MOBILE COMMUNICATION SERVICE PROVIDER'S MARKET SHARE

(71) Applicant: DEUTSCHE TELEKOM AG, Bonn (DE)

(72) Inventors: Barak CHIZI, Ashkelon (IL); Yuval ELOVICI, Arugot (IL); Dudu MIMRAN, Tel Aviv (IL); Lior ROKACH, Omer (IL)

(73) Assignee: DEUTSCHE TELEKOM AG

(21) Appl. No.: 14/534,702

(22) Filed: Nov. 6, 2014

(30) Foreign Application Priority Data
Nov. 11, 2013 (IL) 229393

(51) Int. Cl. G06Q 30/02; H04W 8/00

(52) U.S. Cl. CPC G06Q 30/0201; H04W 8/005
USPC 705/7.29

(57) ABSTRACT

A method of enabling a specific mobile communication service provider (Dt) to estimate his market share on a street level in real time during a specific period of time over a particular point of interest (POI) is disclosed.

### FIELD OF THE INVENTION

The invention is from the field of mobile communication. Specifically the invention relates to a method of determining the market share of a mobile communication service provider.

### BACKGROUND OF THE INVENTION

For any mobile communication service provider, knowing his exact market share gives him a competitive advantage over other providers. This knowledge enables the provider to plan his marketing strategy in order to gain more customers in specific geographical locations. At the present time market share data is usually static data supplied on the level of an entire city and is mostly based on sampling or through an expert's estimation.

It would be much more helpful to have the data relating to market share provided at the level of neighborhoods, streets, or individual buildings in a dynamic matter.

It is a purpose of the present invention to provide a method, which provides such data.

Further purposes and advantages of this invention will appear as the description proceeds.

### SUMMARY OF THE INVENTION

The invention is a method of enabling a specific mobile communication service provider (Dt) to estimate his market share on a street level in real time during a specific period of time over a particular point of interest (POI). The method comprises:
a. determining the total number of handsets that are generating any registration event in the network that involves information regarding the location of the device (active handsets) served by Dt in said POI during said period of time (ADDt);
b. determining the ratio (AMD) of the number of active handsets served by Dt to the total number of handsets served by Dt in said POI during said period of time ;
c. determining the ratio (SMB) of the number of non-active handsets served by Dt to the total number of handsets served by Dt in said POI during said period of time;
d. obtaining from the manufactures the total number of handsets of model i that have been sold to customers of all providers of mobile communication services in said POI;
e. determining the number of handsets of model i that are serviced by Dt in said POI;
f. determining the ratio (HSTiDt) of handsets of model i that have been sold to customers of Dt to the number of handsets of model i that have been sold to customers of all providers of mobile communication services in said POI;
g. determining the number (PHSTiDt) of handsets of model i serviced by Dt that are generating active signals at the POI during said specific period of time;
h. determining the total number (ADi) of active devices of model i serviced by all service providers in said in said POI during said period of time designated, wherein ADi,=PHSTiDt/HSTiDt;
i. determine the total number (ADn) of active devices for all n models of handsets for which sales information is available, wherein

$$ADn = {\sum }_{1 = 1}^{n} ( \frac{PHSTiDt}{HSTiDt} ) ;$$

j. determining the market share (MSDt) of Dt, wherein MSDt=ADDt/ADn.

If in step i only k<n models are active then steps i and j are replaced by the steps:
k. determine the total number (ADk) of active devices for all n models of handsets for which sales information is available, wherein

$$ADk = \sqrt[K]{{\prod }_{i = 1}^{K} ( \frac{PHSTi}{( HSTiDt ⋆ IHSTi ) ⋆ SMB} )} ;$$

and
l. determining the market share (MSDt) of Dt, wherein MSDt=ADDt/ADk.

All the above and other characteristics and advantages of the invention will be further understood through the following illustrative and non-limitative description of embodiments thereof.

### DETAILED DESCRIPTION OF EMBODIMENTS OF THE INVENTION

The method of the invention relies on real time computation, i.e. it provides the market share for a specific mobile communication service provider at the rate at which data related to device usage is received from the mobile network.

The method of the invention enables the mobile communication service provider to estimate his market share on a street level in real time over a particular point of interest (POI). The POI can be any geographical region serviced by the provider and can range from whole countries down to groups of offices in a large office building. To deliver such output the method uses the network signaling data, which includes positioning data for active devices. Additionally, by using static data comprising the distribution of different models of devices employed by users in the network and the penetration rate of each model into the market, an accurate estimation of market share can be achieved.

The method of the invention comprises the following three phases:
1. estimating the number of silent users;
2. applying the model distribution; and
3. performing an integrating calculation over the POI.

Estimating the Number of Silent Users

When collecting any cellular identity within a specific POI over time, the signaling data reveals only the active users. The term “active users” refer to the handsets that generate “active signals”, i.e. any registration event in the network that involves information regarding the location of the device. The total number of active handsets served by a specific mobile communication service provider, herein designated Dt, that are active in the specific POI during a specific period of time is designated herein as ADDt.

The ratio of the active handsets to the total number of handsets served by the service provider in the specific POI during the specific period of time is known herein as AMB and is estimated by the following ratio:

$$A M B = \frac{active handsets in the area served by the provider}{the total number handsets served by the provider} = \frac{ADDt}{the total number of handsets served by the provider}$$

Therefore the ratio of the non-active users, i.e. the ratio of handsets that are not generating an active signal at the POI to the total number of handsets served by the service provider in the specific POI during the specific period of time, known herein as SMB, can be estimated as:

SMB=1−AMB

AMB and SMB can be determined for any period of time for which it is desired to know the market share. Non-limiting examples could be between 8:00 and 9:00 on Monday morning, for the first week in July, and between 17:00 and 18:00 each day of the week. The method assumes that once AMB and SMB have been determined for a given time period they will be the same for corresponding time periods, e.g. the values of AMB and SMB determined for the time period between 12:00 and 13:30 on the first Tuesday of the month will be the same for the same hours in the following Tuesdays that occur during comparable periods of the year, i.e. different values of AMB and SMB will be determined for Tuesdays that fall during a holiday period as compared to a regular work day.

Applying Model Distribution

The first phase of the method generates the ratio of non-active users. However, because the active signals that are collected only belong to devices serviced by a specific service provider, SMB does not give the total number of devices that are available in a given POI.

The solution provided by the invention to this problem is based on obtaining from the manufactures the total number of handsets of a specific model that have been sold to customers of all providers of mobile communication services in the POI. If there are n models of handsets for which sales information is available, then for model i the percentage of the total number of handsets of model i sold to customers that are serviced by specific service provider Dt to the total number of handsets of model i sold to customers that are serviced by all service providers is known herein as HSTiDt.

A mandatory requirement for implementing this phase of the method is that sales information regarding at least one model (i=1=n) is available. A basic assumption is that for a specific service provider the percentage of handsets of each type out of the total for that type, i.e. HSTiDt, is constant throughout the service providers range of operation.

Integrating Calculation Over POI

A first input for calculating the market share of a specific mobile communication services provider over a specific POI at a specific period of time is the number of handsets of model i serviced by provider Dt that are generating active signals at that POI and time. This will be known herein as PHSTiDt. A second input is the percentage of the provider's handsets of model i out of the total number of handsets of model i in the POI, i.e. HSTiDt.

Then in the POI the total number of active devices of model i serviced by all service providers, designated ADi, is equal to PHSTiDt/HSTiDt and the total number of active devices for all n models, designated ADn, is:

$$ADn = {\sum }_{1 = 1}^{n} ( \frac{PHSTiDt}{HSTiDt} )$$

Thus, if the required sales information is available for all n models of handsets, the market share of provider Dt at the specific POI for the specific time period, known herein as MSDt, would be the number of active devices receiving services provided by Dt, known herein as ADDt, divided by the total number of active devices serviced by all providers, i.e.

$$MSDt = \frac{ADDt}{{\sum }_{i = 1}^{n} ( \frac{PHSTiDt}{HSTiDt} )} = \frac{ADDt}{ADn} .$$

However, since usually not all n models are active at any given time, an additional property which describes the distribution of handsets within the customers of all of the providers is used. This will be notated as IHSTi, wherein,

$$IHSTi = \frac{number of handsets of model i serviced by all providers}{\begin{matrix}total number of all handsets \\ of all models serviced by all providers\end{matrix}}$$

Therefore the total number of handsets of k different models, wherein k<n serviced by all service providers over a specific POI, designated ADk, will be:

$$ADk = \sqrt[K]{{\prod }_{i = 1}^{K} ( \frac{PHSTi}{( HSTiDt ⋆ IHSTi ) ⋆ SMB} )}$$

wherein, each component in the above harmonic average is divided by SMB in order to estimate the number of users (active and non-active) serviced by all service providers using a specific model in a specific POI.

Therefore the market share of mobile communication service provider Dt in the POI is given by:

$$MSDt = \frac{ADDt}{\sqrt[K]{{\prod }_{i = 1}^{K} ( \frac{PHSTi}{( HSTiDt ⋆ IHSTi ) ⋆ SMB} )}} = \frac{ADDt}{ADk} .$$

Although embodiments of the invention have been described by way of illustration, it will be understood that the invention may be carried out with many variations, modifications, and adaptations, without exceeding the scope of the claims.

1. A method of enabling a specific mobile communication service provider (Dt) to estimate his market share on a street level in real time during a specific period of time over a particular point of interest (POI), said method comprising:
a. determining the total number of handsets that are generating any registration event in the network that involves information regarding the location of the device (active handsets) served by Dt in said POI during said period of time (ADDt);
b. determining the ratio (AMD) of the number of active handsets served by Dt to the total number of handsets served by Dt in said POI during said period of time ;
c. determining the ratio (SMB) of the number of non-active handsets served by Dt to the total number of handsets served by Dt in said POI during said period of time;
d. obtaining from the manufactures the total number of handsets of model i that have been sold to customers of all providers of mobile communication services in said POI;
e. determining the number of handsets of model i that are serviced by Dt in said POI;
f. determining the ratio (HSTiDt) of handsets of model i that have been sold to customers of Dt to the number of handsets of model i that have been sold to customers of all providers of mobile communication services in said POI;
g. determining the number (PHSTiDt) of handsets of model i serviced by Dt that are generating active signals at the POI during said specific period of time;
h. determining the total number (ADi) of active devices of model i serviced by all service providers in said in said POI during said period of time designated, wherein ADi,=PHSTiDt/HSTiDt;
i. determine the total number (ADn) of active devices for all n models of handsets for which sales information is available, wherein
$$ADn = {\sum }_{1 = 1}^{n} ( \frac{PHSTiDt}{HSTiDt} ) ;$$
j. determining the market share (MSDt) of Dt, wherein MSDt=ADDt/ADn.

2. The method of claim 1, wherein in step i only k<n models are active and steps i and j are replaced by the steps:
k. determine the total number (ADk) of active devices for all n models of handsets for which sales information is available, wherein
$$ADk = \sqrt[K]{{\prod }_{i = 1}^{K} ( \frac{PHSTi}{( HSTiDt ⋆ IHSTi ) ⋆ SMB} )} ;$$
and
l. determining the market share (MSDt) of Dt, wherein MSDt=ADDt/ADk.
